(19) United States
(12) Patent Application Publication
(10) Pub. No.: US 2011/0310695 A1
(43) Pub. Date: Dec. 22, 2011

(54) Apparatus and method for particulate confection addition to soft-serve ice cream

(76) Inventors: Gerald A. Sus, Frankfort, IL (US); Glenn Schackmuth, Oswego, IL (US); Rob Carr, Lemont, IL (US); James D. Ryndak, Barrington Hills, IL (US); Jeffrey S. Dixon, Chicago, IL (US)

(21) Appl. No.: 12/803,221

(22) Filed: Jun. 22, 2010

(51) Int. Cl. B01F 15/02

(52) U.S. Cl. 366/177.1

(57) ABSTRACT

A device and method are provided for manually actuated dispensing of a particulate confection from a selected confection hopper into a dispensing stream of soft frozen dessert. The device includes a plurality of confection hoppers with corresponding confection outlets, a manual actuator operatively connected to a dispensing member that cooperates with the confection outlet to dispense only a controlled amount of confection from the corresponding hopper into a confection conduit each time the actuator is actuated, and mixing means for substantially uniformly mixing the controlled amount of confection into a serving amount of the soft frozen dessert as the dessert is dispensed into a serving receptacle.

### FIELD OF THE INVENTION

The present invention relates to manually actuated devices and methods for dispensing and metering a controlled amount of particulate material. More particularly, it relates to dispensing and metering particulate confections into a dispensing stream of soft-serve ice cream to dispense a substantially uniform mixture of ice cream and confection.

### BACKGROUND OF THE INVENTION

There is substantial consumer demand for soft-serve ice cream desserts with added particulate confections (or “mix-ins”) to enhance and customize the texture and flavor of the desserts. However, known high-volume methods of producing such dessert mixtures have drawbacks.

For example, one existing method uses one device to dispense soft-serve ice cream into a serving cup, and a separate device to blend manually added confection into the cup of ice cream, using a detachable single-use blending spoon that is then detached and provided to the customer as a serving spoon. The consistency of this method is dependent on human operator performance, which complicates operations and can lengthen service times, since the soft-serve ice cream is first dispensed and then mixed.

Another existing method uses a complicated and relatively expensive automated, motorized dispensing system, in which an operator enters a key code for one or more mix-ins on a key pad and starts a flow of ice cream, and the dispensing system automatically operates a dispensing motor or motors to dispense the mix-in(s) into the flow of ice cream. This method requires equipment that is expensive to purchase and maintain.

A need therefore exists for a low-cost apparatus and method for high-volume addition of particulate confection to a soft-serve ice cream type of frozen dessert.

### BRIEF SUMMARY OF THE INVENTION

In accordance with one aspect of the present invention, an apparatus is provided for adding a particulate confection into a stream of soft frozen dessert. The apparatus comprises a plurality of particulate confection hoppers, each hopper having a confection outlet, and a manual actuator operatively connected to a dispensing member adjacent the confection outlet of a selected hopper and configured to be actuated to mechanically move the dispensing member to dispense only a controlled amount of confection from the hopper through the confection outlet. The elements of the apparatus are configured to cause the dispensed controlled amount of confection to flow into a confection passageway. Mixing means in communication with the confection passageway are configured to substantially uniformly mix confection from the confection passageway into a dispensing stream of soft frozen dessert.

In one embodiment, the actuator is configured to selectively dispense any of a plurality of different controlled amounts. For example, the actuator may be movable to and from a dispensing position and any of a plurality of dispensing amount positions, each dispensing amount position corresponding to a predetermined amount of confection to be dispensed, such that the actuator is configured to dispense a selected amount of confection by moving the actuator to a selected dispensing amount position and from the selected dispensing amount position to the dispensing position. The manual actuator may be a lever or any other suitable mechanical member.

In another embodiment, the mixing means is a metering device mechanically linked to a soft frozen dessert dispensing device to meter the controlled amount of confection from the confection passageway into a dessert that is being dispensed from the dessert dispensing device so that the controlled amount of confection is substantially evenly mixed into a predetermined serving amount of the dessert.

In still another embodiment, the apparatus comprises a plurality of manual actuators, including at least one mechanical actuator corresponding to each hopper. Each actuator may be integrally connected to the corresponding dispensing member to form a unitary body comprising the actuator and the dispensing member.

In yet another embodiment, the dispensing member comprises a body that includes an obstructing surface and a metering cavity adjacent the obstructing surface. The obstructing surface is selectively positionable to cover a confection outlet of one of said hoppers to obstruct the flow of confection out of the hopper, while the metering cavity is selectively positionable in communication with the confection outlet to permit a predetermined amount of confection to pass out of the hopper and into the metering cavity. To permit dispensing of the predetermined amount of confection, the metering cavity is then selectively positionable in communication with the confection passageway to cause the predetermined amount of confection to pass out of the metering cavity and into the confection passageway.

In accordance with another aspect of the present invention, a mechanism is provided for controlled addition of particulate confection into a stream of soft frozen dessert. The mechanism comprises a substantially enclosed hopper having an open confection outlet, the hopper mounted for rotational movement to and from a dispensing orientation in which the confection outlet is aligned with a confection conduit and a loading orientation in which the confection outlet is not aligned with the confection conduit. A plurality of baffles in the hopper define a passageway connecting the interior of the hopper to the confection outlet such that a pathway through the passageway from the interior of the hopper to the confection outlet includes an upward pathway segment and a subsequent downward pathway segment when the hopper is in the dispensing orientation. The baffles are configured to at least partially restrain upward flow of particulate matter so that particulate confection contained in the hopper is at least substantially prevented from traversing the upward pathway segment when the hopper is in the dispensing orientation. For example, the baffles may be configured so that the upward pathway segment is long enough or narrow enough to cause frictional blockages preventing continuous upward flow of a particulate confection through the upward pathway segment. In this manner, continuous dispensing flow of the particulate confection when the hopper is in the dispensing orientation is at least substantially prevented, and while substantially only a dispensing flow of a controlled amount of “loaded” particulate confection that has already traversed the upward pathway segment is permitted. To permit the controlled amount to be so loaded for dispensing, the baffles are configured so that when the hopper is rotated from the dispensing orientation to the loading orientation in a first direction, the upward pathway segment is at least partially inverted so that the controlled amount of particulate confection, initially contained in the hopper below the upward pathway segment, traverses the upward pathway segment and reaches a location adjacent the downward pathway segment. Then, when the hopper is rotated from the loading orientation back to the dispensing orientation in a second direction opposite to the first direction, the controlled amount of particulate confection traverses the downward pathway segment and is directed through the confection outlet out of the hopper and into a confection conduit.

### BRIEF DESCRIPTION OF THE DRAWINGS

FIG. 1 is a schematic illustration of a device for adding particulate confection into a stream of soft frozen dessert.

FIG. 2 is a schematic illustration of an alternative particulate confection addition device.

FIG. 3 is a schematic illustration of another alternative particulate confection addition device.

FIG. 4 is a schematic illustration of still another alternative particulate confection addition device.

FIG. 5 is a schematic illustration of yet another alternative particulate confection addition device.

FIG. 6 is a perspective view of a confection dispensing mechanism for a particulate confection addition device having a cylinder with a metering cavity.

FIG. 7 is a front schematic view of the confection dispensing mechanism of FIG. 6, revealing internal components and features.

FIG. 8 is a schematic illustration of a potential confection-overflow design concern for a confection dispensing mechanism having a cylinder with a metering cavity.

FIG. 9 is a schematic illustration of an alternative confection dispensing mechanism having a cylinder with a metering cavity.

FIG. 10 is a schematic illustration of a confection dispensing mechanism having a cylinder with multiple metering cavities.

FIG. 11 is a schematic illustration of a confection dispensing mechanism having a vertically slidable piston with a metering cavity.

FIG. 12 is a schematic illustration of a confection dispensing mechanism having a horizontally slidable drawer-like member with a metering cavity, shown in a loading orientation.

FIG. 13 is a schematic illustration of the confection dispensing mechanism of FIG. 12, shown in a dispensing orientation.

FIG. 14 is an exploded perspective view of the confection dispensing mechanism of FIGS. 12-13.

FIG. 15 is an exploded perspective view of a confection dispensing mechanism including a rotatably mounted hopper with baffles.

FIG. 16 is an assembled perspective view of the confection dispensing mechanism shown in FIG. 15.

FIG. 17 is a front schematic illustration of a confection dispensing mechanism of the type shown in FIGS. 15 and 16 in a dispensing orientation containing particulate confection at rest.

FIG. 18 is a front schematic illustration of the confection dispensing mechanism of FIG. 17 partially rotated counterclockwise toward a loaded orientation.

FIG. 19 is a front schematic illustration of the confection dispensing mechanism of FIG. 17 in a loaded orientation.

FIG. 20 is a front schematic illustration of the confection dispensing mechanism of FIG. 17 partially rotated clockwise from the loaded orientation toward the dispensing orientation.

FIG. 21 is a front schematic illustration of the confection dispensing mechanism of FIG. 17 in the dispensing orientation, showing a controlled amount of particulate confection being dispensed through a confection outlet.

FIG. 22 is a front schematic illustration of a confection dispensing mechanism including a rotatably mounted hopper with baffles of alternative proportions.

### DETAILED DESCRIPTION OF THE INVENTION

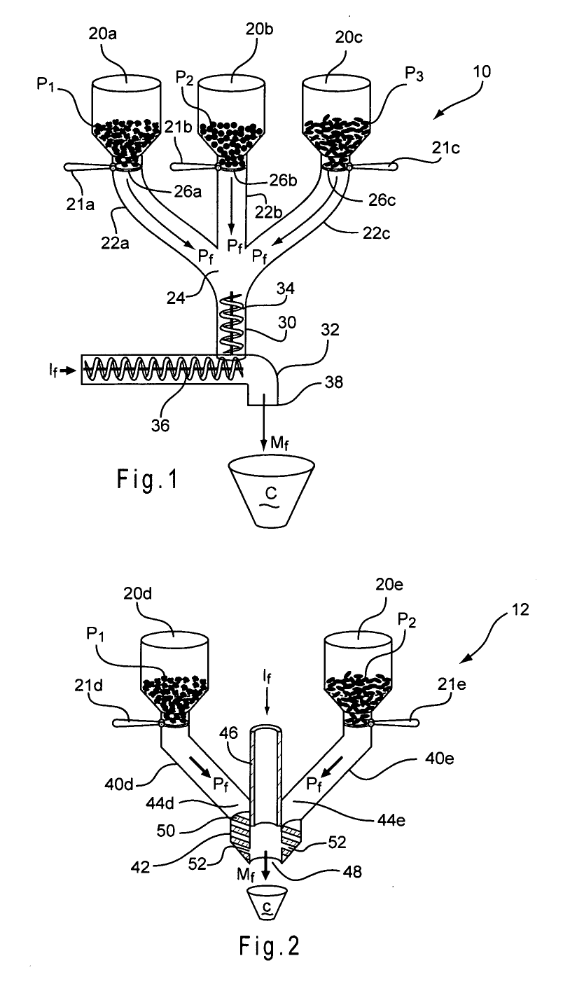

With reference to the Figures generally, in accordance with the present invention, devices and methods for adding particulate confection into a stream of soft frozen dessert, with manually actuated confection dispensing, are disclosed. Referring to FIGS. 1-5, respectively, devices 10, 12, 14, 16, and 18 embodying different forms of a device according to the invention are illustrated schematically. Each device 10-18 includes a plurality of confection hoppers 20 connected to a confection conduit system for directing a plurality of different particulate confections P to a flow of semi-liquid frozen dessert, typically soft-serve ice cream, I_{f}, and a manual dispensing mechanism 21a-21k for dispensing a selected particulate confection P into the confection conduit system. Devices 10-18 differ in the arrangement of the confection conduit system with respect to the confection hoppers and to an ice cream dispensing conduit. Manual dispensing mechanism 21a-21k is only illustrated schematically in FIGS. 1-5, but more detailed examples of suitable structures for a manual confection dispensing actuator according to the present invention are shown and described further below with reference to FIGS. 6-12.

Referring to FIG. 1, device 10 includes confection hoppers 20a-20c having particulate confections P₁-P₃ stored therein, each hopper 20a-20c connected to its own inlet passage 22a-22c, respectively, of a confection conduit system 24. Each hopper 20a-20c includes a respective confection outlet 26a-26c and a respective manual actuator 21a-21c configured to be actuated to selectively dispense the respective particulate confection P₁-P₃ through the respective outlet 26a-26c and into the respective inlet passage 22a-22c of conduit system 24. By the force of gravity, particulate confection P in any inlet passage 22a-22c then passes in a particulate flow direction indicated by arrows P_{f} into a common confection passage 30 in communication with an ice cream dispensing passage 32. Dispensing passage 32 may be connected to or comprise a part of any soft-serve freezer (not shown) suitable for dispensing ready-to-eat ice cream into a serving cup. Preferably, a driven auger 34, driven by a suitable motor (not shown), or other suitable metering mechanism is disposed within and in cooperation with common passage 30 to meter particulate confection P into ice-cream dispensing passage 32 at a rate proportional to that of a flow of ice cream I_{f} in dispensing passage 32, so that particulate confection P is evenly distributed throughout a serving of ice cream. The rotation of driven auger 34 may also help to prevent backflow of pressurized ice cream from dispensing passage 32 into common confection passage 30. A driven auger 36 may be disposed in dispensing passage 32 adjacent common confection passage 30 to control the flow rate of ice cream and/or to promote even mixing of particulate confection P into the flow of ice cream. The relative rotation and diameter of driven augers 34 and 36 can be matched to provide the desired input of particulate confection P into a desired volume of ice cream. Dispensing passage 32 is in communication with a dispensing outlet 38, through which the mixture of ice cream and particulate confection P passes out of device 10 and into a serving cup C, as indicated by arrow M_{f}. It is to be understood that the soft-serve ice cream can be dispensed into any container as desired, including, a bowl, an ice cream cone or an ice cream-type carton, for example.

FIGS. 2-5 are schematic depictions of various alternative arrangements of conduit and mixing systems for mixing an ice cream flow I_{f} and a particulate confection flow P_{f}. Device 12, illustrated schematically in FIG. 2, is an alternative embodiment of a device according to the invention. In device 12, each hopper 20d, 20e has an associated manual actuator 21d, 21e and is connected to a separate confection conduit 40d, 40e, each leading directly to a mixing chamber 42 via a separate inlet 44d, 44e. An ice cream dispensing conduit 46 leads through mixing chamber 42 to a dispensing outlet 48, so that ice cream flow I_{f} passes through the center of an annular auger 50 disposed in mixing chamber 42. Auger 50 is configured to meter confection particles into ice cream flow I_{f} through apertures 52. Preferably, auger 50 is also adapted to spin rapidly enough so that the downward force of its blades substantially prevents any backflow of pressurized ice cream from passing through apertures 52 and up through auger 50 into confection conduits 40d, 40e, which could adversely affect the sanitation of device 12 and/or product quality.

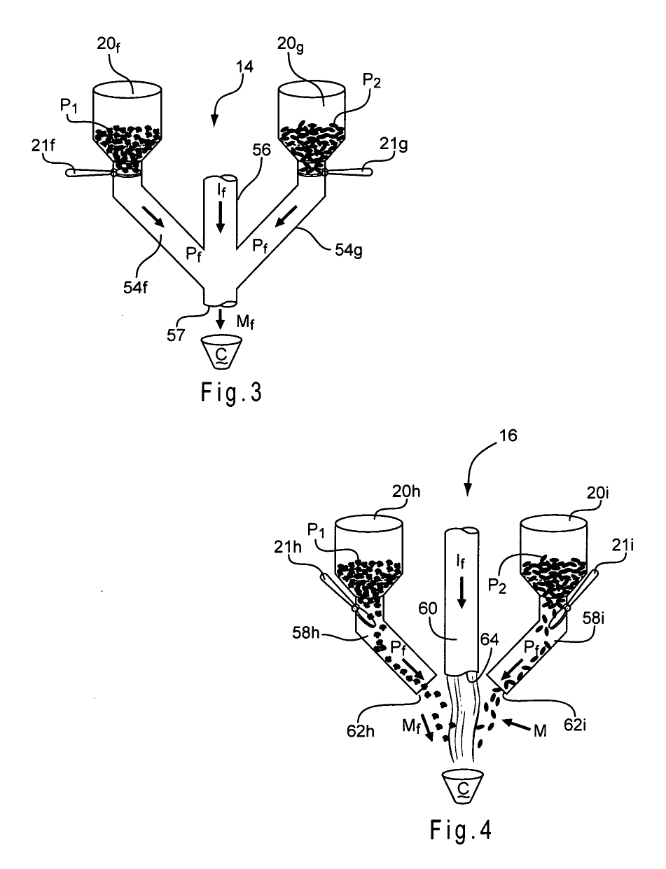

Illustrating another alternative embodiment, a device 14 shown in FIG. 3 includes separate conduits 54f, 54g, each leading directly from a respective hopper 20f, 20g with a respective manual actuator 21f, 21g into an ice cream dispensing conduit 56. In dispensing conduit 56, a particulate confection flow P_{f} passively mixes with an ice cream flow I_{f} to form a mixed flow M_{f} of a mixture M which exits a dispensing outlet 57 into a serving cup C. It is to be understood that the soft-serve ice cream can be dispensed into any container as desired, including, a bowl, an ice cream cone or an ice cream-type carton, for example.

Still another alternative embodiment is shown in FIG. 4. A device 16 includes confection conduits 58h-58i leading from hoppers 20h, 20i, each having a respective manual actuator 21h, 21i. Confection conduits 58h, 58i are not connected to an ice cream dispensing conduit 60, but rather include confection dispensing outlets 62h, 62i for dispensing a particulate confection flow P_{f} into the atmosphere. Confection dispensing outlets 62h, 62i are preferably disposed adjacent to and facing toward an ice cream dispensing outlet 64 of ice cream dispensing conduit 60, so that a particulate confection flow P_{f} exiting either or both of outlets 62h, 62i impinges on an ice cream flow I_{f} to substantially evenly coat the ice cream flow I_{f} to form a mixed flow M_{f} to be dispensed into a serving cup C. It is to be understood that the soft-serve ice cream can be dispensed into any container as desired, including, a bowl, an ice cream cone or an ice cream-type carton, for example.

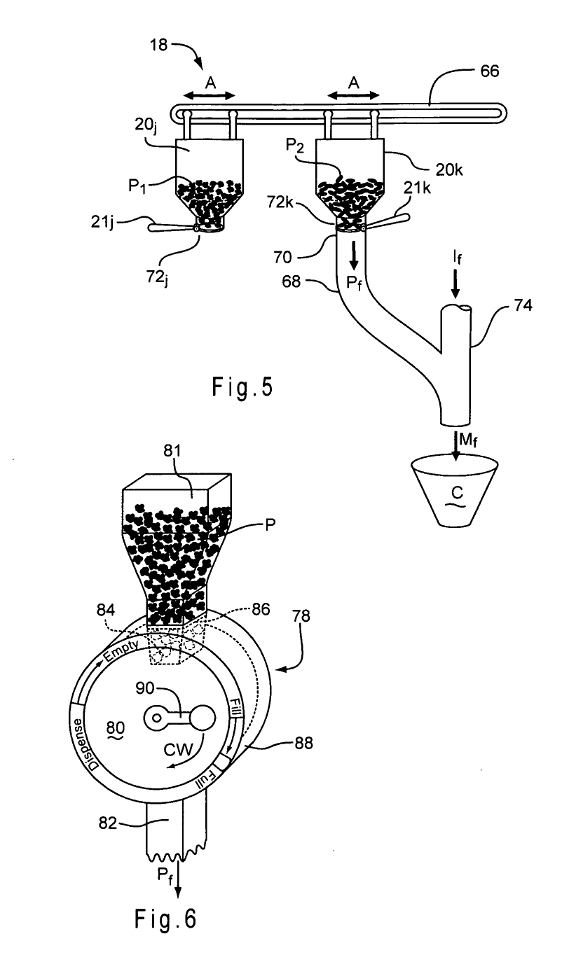

Yet another alternative embodiment is illustrated schematically in FIG. 5. In a device 18 as illustrated, hoppers 20j, 20k are slidably mounted to a sliding bracket 66 for horizontal movement with respect to a single confection conduit 68 having a top opening 70, in the directions indicated by arrows A. In this manner, a confection outlet 72j, 72k of a selected hopper 20j, 20k can be selectively aligned with opening 70. A manual dispensing mechanism 21j, 21k associated with the selected hopper can then be actuated to cause a corresponding particulate confection P₁-P₂ to pass out of a confection outlet 72j, 72k of the selected hopper 20j, 20k and into confection conduit 68 via opening 70. Although confection conduit 68 is shown as leading directly to an ice cream dispensing outlet 74 so that particulate flow P_{f} and ice cream flow I_{f} may mix passively therein to form a mixed flow M_{f} for dispensing into a serving cup C; it should be noted that any suitable mixing arrangement of a confection conduit and an ice cream dispensing conduit may be chosen as desired in conjunction with the single-conduit arrangement of device 18. It is to be understood that the soft-serve ice cream can be dispensed into any container as desired, including, a bowl, an ice cream cone or an ice cream-type carton, for example.

In a method according to the invention for dispensing a single-serving amount of soft-serve ice cream with uniformly mixed-in particulate confection, a human operator would simply dispense a single-serving amount of particulate confection by manually moving the selected manual actuator 21a-21k, initiate the dispensing flow of ice cream, and terminate the flow of ice cream when a single-serving amount of ice cream mixture has been dispensed. Where a powered particulate confection metering device is employed to automatically meter confection into the dispensing stream of ice cream, which may resemble, for example, auger 34 or auger 50 of the embodiments illustrated in FIGS. 1 and 2, respectively, the operator would preferably first dispense the single-serving amount of particulate confection to permit the confection to come into contact with the metering device, and then initiate the dispensing flow of ice cream. Preferably, an apparatus with a powered particulate confection metering device according to the invention is configured so that the flow of ice cream and the metering device are simultaneously initiated by the same actuator (not shown). For example, the actuator for initiating the ice cream flow and the metering device could be a manual lever of the type commonly found in basic soft-serve ice cream dispensing apparatus, Wherein dispensing flow is typically initiated by pulling down the lever and typically terminated by raising or simply releasing the lever to permit biasing forces to raise it to its initial position.

On the other hand, where a powered particulate confection metering device is not employed, as in the embodiments illustrated in FIGS. 3-5, an operator would preferably dispense the single-serving amount of particulate confection and initiate the dispensing flow of ice cream at substantially the same time, to facilitate passive mixing of the streams of confection and ice cream. It should be noted, however, that the lack of a powered particulate confection metering device is not an essential aspect of the embodiments illustrated in FIGS. 3-5, and it is within the scope of the invention to incorporate appropriate metering means for directing particulate confection at a controlled rate into the ice cream dispensing conduits shown in FIGS. 3 and 5 or into the ambient as in FIG. 4.

Turning to FIGS. 6-14, some alternative examples of suitable structures for a manual confection dispensing mechanism according to the invention, which may be employed as manual dispensing mechanism 21a-21k in any of the embodiments described above, are illustrated in more detail.

Referring to FIG. 6, a manual dispensing mechanism 78 comprises a cylinder 80 rotatably mounted with respect to a hopper 81 and a confection conduit 82. Cylinder 80 includes a metering cavity 84 configured to receive a metered amount of particulate confection P when aligned with confection outlet 86 of hopper 81, and to dispense the metered amount of confection P into confection conduit 82 when aligned therewith. Outlet 86 has a curved profile closely conforming to the circumference of cylinder 80 so that cylinder 80 blocks outlet 86 to at least substantially prevent any unwanted spillage of confection P from hopper 81 when cavity 84 is not aligned with outlet 86. A dispenser enclosure 88 substantially surrounds the circumferential portions of cylinder 80 that are not aligned with outlet 86 or confection conduit 82, to prevent contamination of confection P. Enclosure 88 is in communication with confection conduit 82, so that any incidental spillage out of cavity 84 is guided around the curved profile of enclosure 88 and into confection conduit 82. In operation, a crank 90 attached to cylinder 80 serves as an actuator that may be turned to rotate cylinder 80 until cavity 84 is in alignment with confection outlet 86, where cavity 84 is filled with confection P. Then, crank 90 may be turned further until cavity 84 is inverted and either directly aligned with confection conduit 82 or aligned with an optional radial gap between cylinder 80 and enclosure 88 defining a flow passage to conduit 82, thus causing confection P to flow out of cavity 84 and through confection conduit 82 in particulate flow direction P_{f}.

A ratchet mechanism (not shown) may optionally be operatively connected to cylinder 80 to permit cylinder 80 to be rotated in only one direction, for example, in the clockwise direction indicated by arrow CW. In normal operation, an operator is thus able to tell that cavity 84 is full of confection when crank 90 is at a fill position or up to about 180 degrees clockwise past the fill position, and that cavity 84 is empty when crank 90 is at or up to about 180 degrees clockwise past a dispense position. As shown in FIG. 6, indicia printed on or adjacent to enclosure 88 may indicate to the operator the locations of the fill and dispense positions and of the ranges of positions of crank 90 in which cavity 84 is full or empty during normal operation. In this manner, an operator can easily avoid accidentally dispensing an unwanted type of confection that is unexpectedly already in cavity 84 into a serving cup by simply observing that crank 90 is in a “full” position and rotating crank 90 to an “empty” position to purge cavity 84 of any undesired confection, allowing the undesired confection to pass out of the device through a dispensing outlet, and properly disposing of the undesired confection. Then, the operator may proceed with the normal serving process by placing a cup proximate to a dispensing outlet of the device, further rotating crank 90 to the “fill” position to fill cavity 84 with a desired confection, starting a flow of ice cream to be mixed with the desired confection, and rotating crank 90 back to the “dispense” position again to dispense the desired confection into the flow of ice cream.

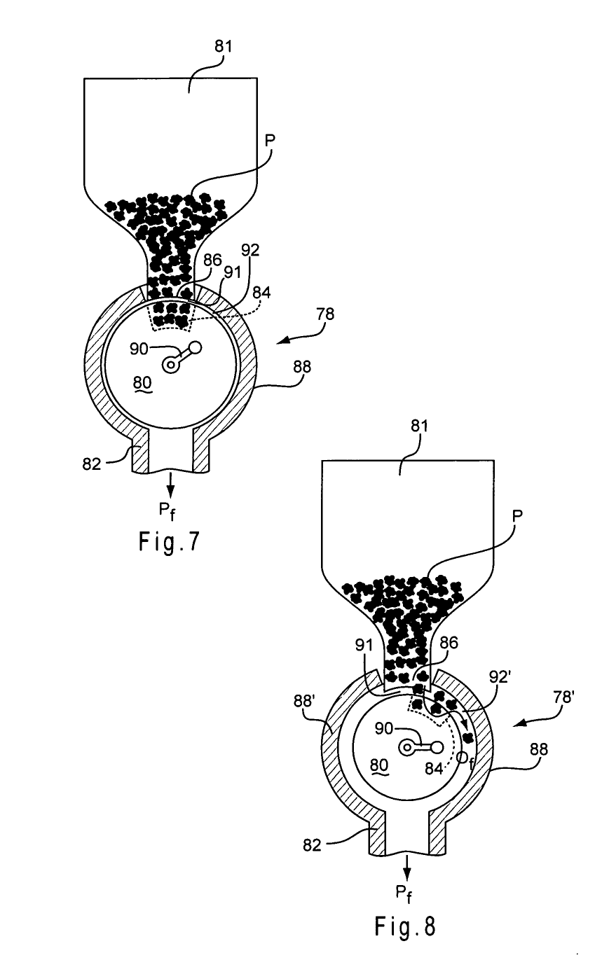

Referring to FIG. 7, spill prevention features of dispenser mechanism 78 are illustrated schematically. In particular, any gap 91 between the circumference of cylinder 80 and confection outlet 86 of hopper 81 should be small enough to substantially prevent confection P from passing out of confection outlet 86 when confection outlet 86 is not aligned with cavity 84 of cylinder 80. Thus, gap 91 should be smaller than the diameter of substantially all particles of confection P. Similarly, it may be desirable for any gap 92 between cylinder 80 and the portion of enclosure 88 adjacent confection outlet 86 to be small enough to substantially prevent the situation illustrated in FIG. 8, in which confection flowing out of outlet 86 causes an overflow O_{f} through cavity 84 and into a large cylinder-enclosure gap 92′ of a modified dispensing mechanism 78′ when cavity 84 is partially aligned with confection outlet 86 and partially aligned with the adjacent portion of a modified enclosure 88′, thus resulting in dispensing more than the desired amount of confection that fills cavity 84. However, to the extent that frictional clogging is sufficient to prevent overflow of a full cavity 84 in this orientation, as may frequently be the case with typical particulate confections, it will be understood that small gap 92 is not necessary and large gap 92′ is acceptable. As a side note, in view of the aforementioned tendency of solid particulate flow to become blocked, it should also be noted that in any embodiment described herein with reference to FIGS. 6-14 of a dispensing mechanism for a particulate confection addition apparatus, it may be desirable or necessary to position a suitable agitating mechanism (not shown) in each hopper adjacent the confection outlet, to thereby loosen any clumps or blockages that could impede confection flow or jam the movement of a dispensing member relative to the confection outlet. The agitating mechanism may be motorized or manual, and if manual, may be a servo mechanism configured to operate when the dispensing member is moved.

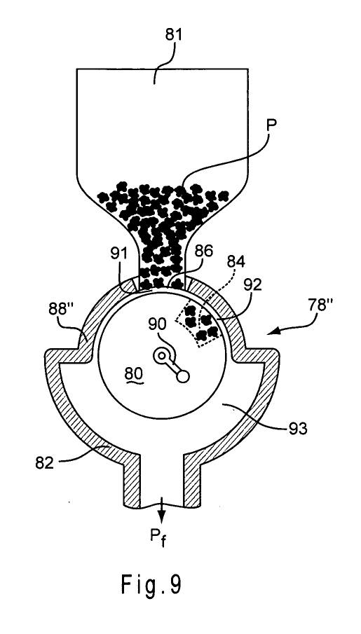

With reference to FIG. 9, even if a small cylinder-enclosure gap 92 adjacent confection outlet 86 is required to prevent overflow of cavity 84, it may be desirable in an alternative dispensing mechanism 78″ to configure a large gap 93 between cylinder 80 and an alternative enclosure 88″, large gap 93 being angularly separated from confection outlet 86 by at least the arcuate width of cavity 84. In this embodiment, cavity 84 is not permitted to be simultaneously in communication with confection outlet 86 and large gap 93, thus avoiding the situation illustrated in FIG. 8. Nonetheless, large gap 93 may advantageously permit confection P to begin emptying from a partially inverted full cavity 84 before cavity 84 is aligned with confection conduit 82, thus providing more time for cavity 84 to empty completely as cavity 84 is rotated towards confection conduit 82.

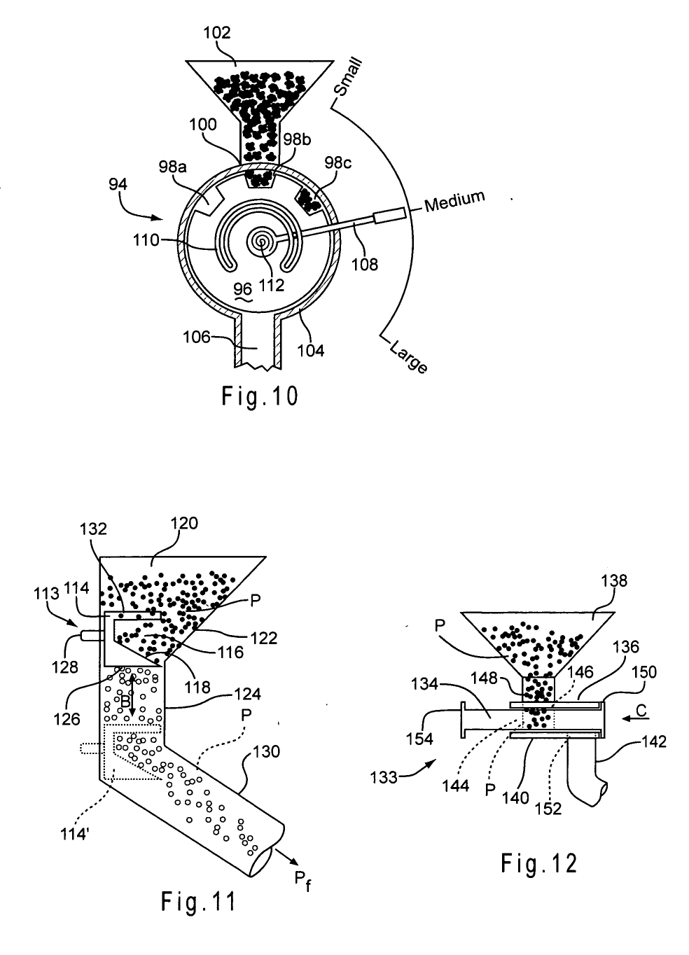

FIG. 10 is an illustration of an alternative dispensing mechanism 94 similar to mechanisms 78-78″ shown in FIGS. 6-9, but having a dispensing cylinder 96 with three angularly spaced apart cavities 98a-98c adapted to receive particulate confection P through a confection outlet 100 of a hopper 102, similarly to cavity 84 as described above. Cylinder 96 is rotatably mounted within an enclosure 104 in communication with a confection conduit 106, also substantially as described above. However, instead of a continuously rotatable crank, cylinder 96 is actuated by a lever 108 with a range of motion limited by an arcuate slot 110 (or by other suitable stop members, not shown). In operation, lever 108 may be pulled clockwise to a desired “small,” “medium” or “large” size position to align one, two or all three of cavities 98a-98c in turn with confection outlet 100, and then released, when a return spring 112 causes cylinder 96 to turn back in the counterclockwise direction until each cavity 98c, 98b, and 98a in turn is aligned with and permitted to empty into confection conduit 106. In this manner, a single actuator, lever 108, may be employed to selectively dispense three different amounts of particulate confection P corresponding to three different serving sizes of frozen dessert, each amount requiring only a single pull of lever 108 to the selected size position. Preferably, appropriate indicia corresponding to the size positions are printed on any suitable surface that is fixed with respect to hopper 102, for example as shown in FIG. 10.

With reference to FIG. 11, an alternative dispensing mechanism 113 is illustrated, including a dispensing member 114. Dispensing member 114 is a piston member that is partially hollowed out to define a cavity 116 with a right side opening and a sloped bottom 118 sloping downwardly towards the right side opening. Dispensing member 114 is slidably mounted with respect to a hopper 120 in the vertical directions indicated by arrow B for movement to and from an uppermost position, depicted in solid lines, and a lowermost position, depicted in dashed lines and indicated as 114′. In the uppermost position, dispensing member 114 is disposed substantially entirely within a tapered portion 122 and above a neck portion 124 of hopper 120. Cavity 116 is exposed to tapered portion 122 of hopper 120 and thus permitted to substantially fill with a controlled amount of a particulate confection P contained in hopper 120, while a bottom surface 126 of dispensing member 114 substantially blocks or prevents confection P from entering neck portion 124. Then, an operator slides dispensing member 114 downward to the lowermost position by grasping and moving an actuator handle 128, which exposes cavity 116 to a confection conduit 130, causing the controlled amount of confection P to flow out of cavity 116 along sloped bottom 118 and along confection conduit 130 in the particulate flow direction indicated by arrow P_{f}. While dispensing member 114 is in the lowermost position, an upper surface 132 of dispensing member 114 blocks neck portion 124 of hopper 120 to prevent any additional confection P from escaping directly into conduit 130 from hopper 120.

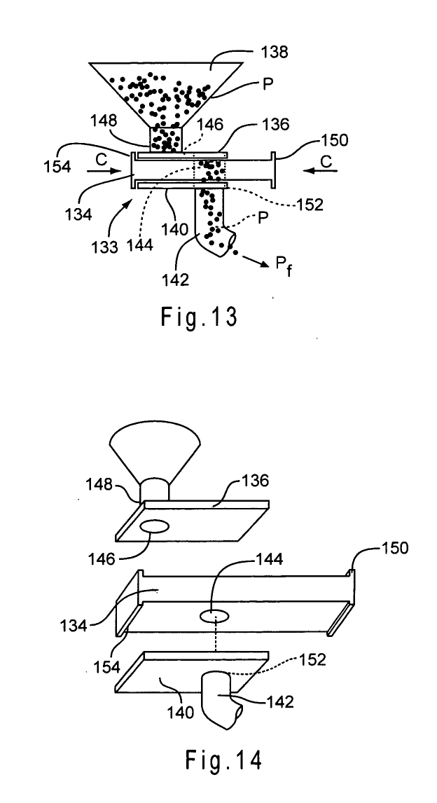

Turning to FIGS. 12-14, another alternative dispensing mechanism 133 including a dispensing member 134 is illustrated, where two operative positions of dispensing member 134 are shown in FIGS. 12 and 13, and FIG. 14 is an exploded view illustrating the shape of the dispensing member and its alignment with other components of a dispensing device according to the invention. Dispensing member 134 is a drawer-like member slidably mounted between a hopper plate 136 of a hopper 138 and a conduit plate 140 of a confection conduit 142. Dispensing member 134 is slidably movable to and from a fill position, shown in FIG. 12, and a dispense position, shown in FIG. 13. In operation, dispensing member 134 is pulled or pushed in the direction indicated by arrow C to reach the fill position shown in FIG. 12, where a cavity 144 of dispensing member 134 aligns with an aperture 146 of hopper plate 136, which is in communication with a confection outlet 148 of hopper 138, and a controlled amount of particulate confection P is permitted to flow into and substantially fill cavity 144. A stopper flange 150 on dispensing member 134 abuts plates 136 and 140 when dispensing member 134 is in the fill position to prevent dispensing member 134 from being moved past the fill position in the direction indicated by arrow C in FIG. 12 and to provide a visual indicator to an operator that dispensing member 134 is in the fill position. Then, dispensing member 134 is moved in the direction indicated by arrow C in FIG. 13 to the dispense position shown in FIG. 13, where cavity 144 aligns with an opening 152 in conduit plate 140 leading to conduit 142, permitting confection P to pass through conduit 142 in the particulate flow direction indicated by arrow P_{f}. A stopper flange 154 on dispensing member 134 abuts plates 136 and 140 when dispensing member 134 is in the dispense position to prevent dispensing member 134 from being moved past the dispense position in the direction indicated by arrow C in FIG. 13 and to provide a visual indicator to an operator that dispensing member 134 is in the dispense position. If desired, biasing means (not shown) may be provided to bias dispensing member 134 toward the dispense position to avoid the potential problem of an operator inadvertently leaving cavity 144 full of confection between serving cycles. Where biasing means are included, an operator would simply move dispensing member 134 into the fill position and then release it, when dispensing member 134 would automatically return to the dispense position to dispense confection P into conduit 142.

It will be understood that flanges 150 and 154, apart from acting as stop members, also provide convenient pull-grip portions of dispensing member 134 for pulling dispensing member 134 toward the dispense and fill positions, respectively. In addition, although not shown, a device incorporating dispensing member 134 should include appropriate tracking means for limiting the movement of dispensing member 134 to sliding movement in the directions indicated by arrows C in FIGS. 12 and 13, which may, for example, be provided by sidewalls attached between plates 136 and 140 to define a sleeve in which dispensing member 134 is slidably mounted or by a mating band-groove connection between dispensing member 134 and one or both of plates 136 and 140.

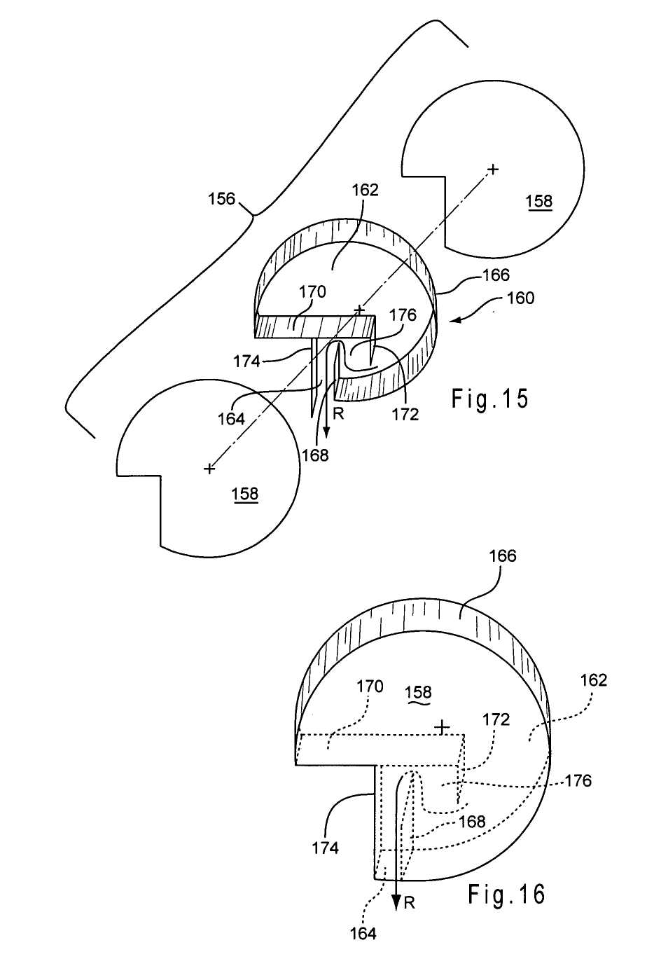

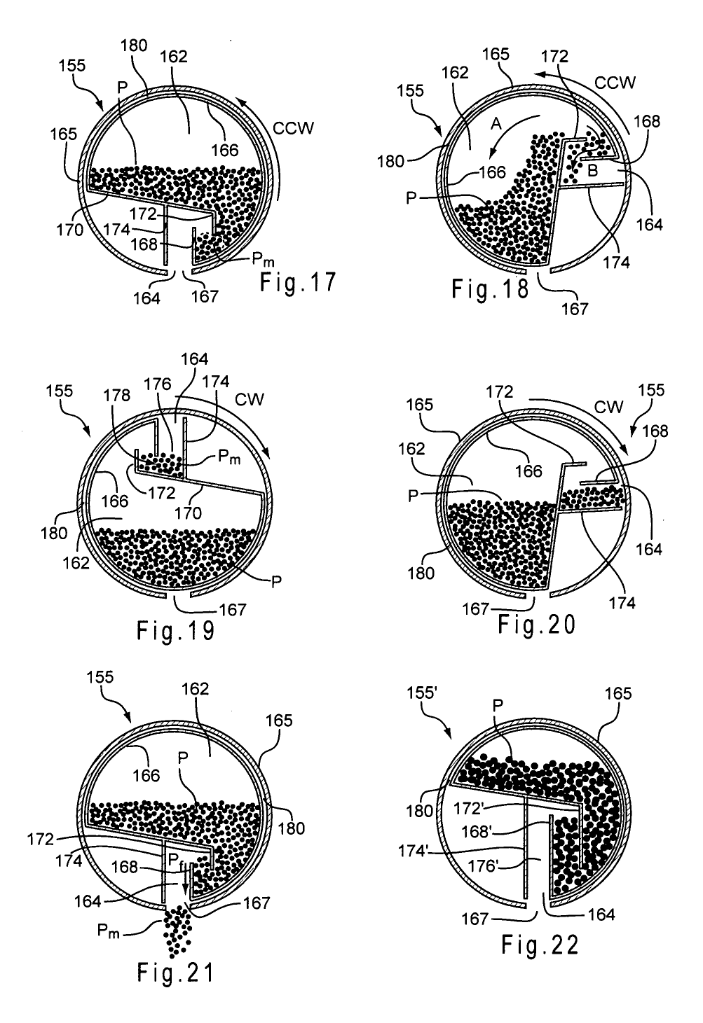

Turning to FIGS. 15-21, yet another embodiment of a dispensing mechanism 155 according to the invention is illustrated schematically. A dispensing hopper 156, shown in exploded view in FIG. 15, is formed from a pair of generally parallel and generally planar front and rear walls 158 and a sidewall structure 160 disposed between front and rear walls 158 to define a substantially enclosed hopper volume 162 with a confection outlet 164 that faces downward in a dispensing orientation seen in FIGS. 15, 16, 17, and 21. A stationary enclosure 165 substantially surrounds dispensing hopper 156 and includes a confection outlet 167 that aligns with confection outlet 164 of hopper 156 when hopper 156 is in the dispensing orientation. Sidewall structure 160 includes a generally circular arcuate outer wall portion 166, a vertically extending, generally straight upward baffle 168 attached to one end of arcuate outer wall portion 166, a sloped wall portion 170 attached to and directed in a downward sloped direction from the other end of arcuate outer wall portion 166 past the horizontal location of upward baffle 168, and a pair of downward baffles 172, 174 attached to sloped wall portion 170 and spaced laterally to the sides of upward baffle 168. Thus, a reticulated outlet passageway 176 is defined, through which particulate confection contained in dispensing hopper 156 must pass to reach outlet 164, first passing under downward baffle 172, then over upward baffle 168, and then downwardly between upward baffle 168 and downward baffle 174, along a reticulated outlet pathway R. The dimensions of outlet passageway 176 are configured to permit lateral or downward flow of particulate confection through passageway 176 but to result in sufficient frictional or clumping blockage to at least substantially prevent particulate confection from flowing upwardly through outlet passageway 176 over the top of upward baffle 168, thus resulting in a static orientation of particulate confection P as illustrated in FIG. 17 when hopper 156 is at rest in the dispensing orientation. A suitable lever, crank, or other manual actuator (not shown) may be included to facilitate manually rotating hopper 156.

The steps for dispensing particulate confection P from dispensing hopper 156 are illustrated schematically in FIGS. 17-21. First, hopper 156 is rotated approximately 180° in the counterclockwise direction indicated by arrow CCW in FIG. 17 to a loaded orientation shown in FIG. 19. During this step, as the orientation of upward baffle 168 and downward baffles 172 and 174 starts to be inverted, only a metered amount of particulate confection Pₘ initially located adjacent upward baffle 168 begins to flow through passageway 176, as indicated by arrow B in FIG. 18, and the remainder of particulate confection P flows down along sloped wall portion 170 towards curved wall portion 166, as indicated by arrow A in FIG. 18. Once hopper 156 reaches the loaded orientation depicted in FIG. 19, the metered amount of particulate confection Pₘ is held in a metered dispensing cup 178 defined by baffles 172 and 174 and part of sloped wall portion 170. Then, in a second step, hopper 156 is rotated back in the clockwise direction denoted CW in FIG. 19 toward the dispensing orientation shown in FIG. 21. As hopper 156 begins to rotate clockwise, metered amount of particulate confection Pₘ starts to flow from metered dispensing cup 178 through the final leg of passageway 176 toward confection outlet 164, as indicated in FIG. 20. As best illustrated in FIG. 20, enclosure 165 closely surrounds hopper 156 so that a gap 180 between confection outlet 164 and enclosure 165 is small enough to prevent spillage of particulate confection whenever confection outlet 164 is not aligned with confection outlet 167. When hopper 156 is fully returned to the dispensing orientation, metered amount of particulate confection then flows out through confection outlets 164 and 167 in a particulate flow direction denoted P_{f} in FIG. 21.

It will be understood that the dimensions of dispensing hopper 156 should be configured to account for the type of particulate confection to be dispensed, as different particulate confections may have different flow characteristics. While the accompanying Figures are illustrative and not drawn to exact scale, one way to adjust the degree of blockage provided by passageway 176 is to vary the length of its straight legs. Thus, in a modified dispensing mechanism 155′ illustrated in FIG. 22, a modified passageway 176′ with longer passageway legs defined by modified baffles 168′, 172′ and 174′ will result in a greater assurance that blockage will occur at some point below the top of upward baffle 168′ to prevent upward flow over upward baffle 168′. Alternatively, a narrower passageway (not shown) will tend to make blockages occur at a shorter distance along the passageway, thus reducing the length of upward baffle required to prevent particulate confection from flowing upwardly over the upward baffle. Also, it should be noted that some variation may occur in the metered amount of particulate confection Pₘ that is dispensed in the two-step dispensing cycle illustrated in FIGS. 17-21, depending on a variety of factors, which may include, for example, variations in particle size and/or shape throughout a bulk volume of a given particulate confection P, the initial amount of particulate confection P present in hopper 156, and variations in the speed at which hopper 156 is rotated in the first or second step, which could result in irregular centrifugal force effects. To minimize the latter problem, it may be desirable to provide a return spring for performing either the first or second step in a consistent manner, while the other step could be performed manually.

While the invention has been described with respect to certain preferred embodiments, as will be appreciated by those skilled in the art, it is to be understood that the invention is capable of numerous changes, modifications and rearrangements, and such changes, modifications and rearrangements are intended to be covered by the following claims.

What is claimed is:

1. An apparatus for adding a particulate confection into a stream of soft frozen dessert, comprising:
a plurality of particulate confection hoppers, each hopper having a confection outlet;
a manual actuator operatively connected to a dispensing member adjacent the confection outlet of a selected hopper and configured to be actuated to mechanically move the dispensing member, to dispense only a controlled amount of confection from the hopper through the confection outlet, and to cause the dispensed controlled amount of confection to flow into a confection passageway; and
mixing means in communication with the confection passageway, the mixing means configured to substantially uniformly mix confection from the confection passageway into a dispensing stream of soft frozen dessert.

2. The apparatus of claim 1, wherein the actuator is configured to selectively dispense any of a plurality of different controlled amounts.

3. The apparatus of claim 2, wherein the actuator is movable to and from a dispensing position and a plurality of dispensing amount positions, each dispensing amount position corresponding to a predetermined amount of confection to be dispensed, such that the actuator is configured to dispense a selected amount of confection by moving the actuator to a selected dispensing amount position and from the selected dispensing amount position to the dispensing position.

4. The apparatus of claim 1, wherein the manual actuator is a lever.

5. The apparatus of claim 1, wherein the mixing means is a metering device mechanically linked to a soft frozen dessert dispensing device to meter the controlled amount of confection from the confection passageway into a dessert that is being dispensed from the dessert dispensing device so that the controlled amount of confection is substantially evenly mixed into a predetermined serving amount of the dessert.

6. The apparatus of claim 1 comprising a plurality of manual actuators according to claim 1, including at least one mechanical actuator corresponding to each hopper.

7. The apparatus of claim 6, wherein the actuator is integrally connected to the dispensing member to form a unitary body comprising the actuator and the dispensing member.

8. The apparatus of claim 1, wherein the dispensing member comprises a body that includes an obstructing surface and a metering cavity adjacent the obstructing surface,
the obstructing surface selectively positionable to cover a confection outlet of one of said hoppers to obstruct the flow of confection out of the hopper,
the metering cavity selectively positionable in communication with the confection outlet to permit a predetermined amount of confection to pass out of the hopper and into the metering cavity, and
the metering cavity selectively positionable in communication with the confection passageway to cause the predetermined amount of confection to pass out of the metering cavity and into the confection passageway.

9. A mechanism for controlled addition of particulate confection into a stream of soft frozen dessert comprising:
a substantially enclosed hopper having an open confection outlet, mounted for rotational movement to and from a dispensing orientation in which the confection outlet is aligned with a confection conduit, the confection conduit being configured to direct confection into the stream of soft frozen dessert, and a loading orientation in which the confection outlet is not aligned with the confection conduit; and
a plurality of baffles defining a passageway connecting the interior of the hopper to the confection outlet such that a pathway through the passageway from the interior of the hopper to the confection outlet includes an upward pathway segment and a subsequent downward pathway segment when the hopper is in the dispensing orientation;
the baffles being configured to at least partially restrain upward flow of particulate matter to at least substantially prevent a particulate confection contained in the hopper from traversing the upward pathway segment when the hopper is in the dispensing orientation, and
the baffles being configured so that when the hopper is rotated from the dispensing orientation to the loading orientation in a first direction, the upward pathway segment is at least partially inverted so that a controlled amount of particulate confection initially contained in the hopper below the upward pathway segment traverses the upward pathway segment and reaches a location adjacent the downward pathway segment, and when the hopper is rotated from the loading orientation back to the dispensing orientation in a second direction opposite to the first direction, the controlled amount of particulate confection traverses the downward pathway segment and is directed through the confection outlet out of the hopper and into the confection conduit.

10. A method of dispensing a single serving of soft frozen dessert with substantially uniformly mixed in particulate confection from a dessert dispensing apparatus for dispensing of soft frozen dessert into a serving container composed of a plurality of particulate confection hoppers, each hopper having a confection outlet, a manual actuator operatively connected to a dispensing member adjacent the confection outlet of a selected hopper and configured to be actuated to mechanically move the dispensing member, to dispense only a controlled amount of confection from the hopper through the confection outlet, and to cause the dispensed controlled amount of confection to flow into a confection passageway, mixing means in communication with the confection passageway, the mixing means configured to substantially uniformly mix confection from the confection passageway into a dispensing stream of soft frozen dessert from the dessert dispensing apparatus, comprising:
initiating the dispensing stream of soft frozen dessert from the dessert dispensing apparatus;
manually moving the manual actuator to dispense the controlled amount of confection through the confection outlet and to cause the controlled amount of confection to substantially uniformly mix with the dispensing stream of soft frozen dessert; and
dispensing a single serving of the substantially uniformly mixed stream into a serving container.

11. The method of claim 10, further comprising initiating particulate confection metering by a powered particulate confection metering mechanism simultaneously with the dispensing stream of soft frozen dessert to direct particulate confection into the dispensing stream at a controlled rate.

12. The method of claim 11, further comprising manually moving only one metering-dispensing actuator to initiate both said particulate confection metering and said dispensing stream of soft frozen dessert.

13. A method of dispensing a controlled amount of a selected particulate confection into a dispensing stream of soft frozen dessert with a dispensing apparatus comprising a plurality of particulate confection hoppers, each hopper having a confection outlet, a manual actuator operatively connected to a dispensing member adjacent the confection outlet of a selected hopper and configured to be actuated to mechanically move the dispensing member, comprising:
moving the manual actuator to move the dispensing member to position a metering cavity of the dispensing member adjacent the confection outlet and to cause the controlled amount of confection to pass from the hopper into the metering cavity;
moving the manual actuator to move the dispensing member to position an obstructing surface of the dispensing member adjacent the confection outlet to at least substantially prevent any additional amount of confection from passing out of the hopper and to position the metering cavity to cause the controlled amount of confection to pass out of the metering cavity and into a dispensing stream of soft frozen dessert.

14. The method of claim 13, further comprising
moving the manual actuator to move the dispensing member to position the metering cavity to cause the controlled amount of confection to pass out of the metering cavity and into a confection passageway;
providing mixing means in communication with the confection passageway, and
operating the mixing means to substantially uniformly mix confection from the confection passageway into a dispensing stream of soft frozen dessert.

15. A method of dispensing a controlled amount of a selected particulate confection into a dispensing stream of soft frozen dessert from a device comprising a substantially enclosed hopper having an open confection outlet, mounted for rotational movement to and from a dispensing orientation in which the confection outlet is aligned with a confection conduit and a loading orientation in which the confection outlet is not aligned with the confection conduit, a plurality of baffles defining a passageway connecting the interior of the hopper to the confection outlet such that a pathway through the passageway from the interior of the hopper to the confection outlet includes an upward pathway segment and a subsequent downward pathway segment when the hopper is in the dispensing orientation, the baffles being configured to at least partially restrain upward flow of particulate matter to at least substantially prevent a particulate confection contained in the hopper from traversing the upward pathway segment when the hopper is in the dispensing orientation, comprising:
rotating the hopper from the dispensing orientation to the loading orientation in a first direction so that the upward pathway segment is at least partially inverted to cause a controlled amount of particulate confection initially contained in the hopper below the upward pathway segment to traverse the upward pathway segment and to reach a location adjacent the downward pathway segment; and
rotating the hopper from the loading orientation back to the dispensing orientation in a second direction opposite to the first direction to cause the controlled amount of particulate confection to traverse the downward pathway segment and to pass through the confection outlet out of the hopper, into the confection conduit, and from the confection conduit into the dispensing stream of soft frozen dessert.
